(19) United States
(12) Patent Application Publication
(10) Pub. No.: US 2006/0227847 A1
(43) Pub. Date: Oct. 12, 2006

(54) Screw on in line shower water thermometer

(76) Inventor: Clifton Ross Johnson, Fort Calhoun, NE (US)

Correspondence Address: Clifton R. Johnson, P.O. Box 108, Blair, NE, 68008, US

(21) Appl. No.: 11/399,510

(22) Filed: Apr. 6, 2006

Related U.S. Application Data
(60) Provisional application No. 60/668,552, filed on Apr. 6, 2005.

(51) Int. Cl. G01K 1/08

(52) U.S. Cl. 374/147

(57) ABSTRACT

This in line rigid coupler designed for easily determining the water temperature flowing from a shower head, incorporates a digital thermometer which offers a fast read, almost instant, reading of temperature with an accuracy of 1/10^{th} of one degree Fahrenheit or Celsius, which is screwed into the coupling using a designed, manufactured, threaded collar, permanently attached to the thermometer sensor probe, allowing insertion of the sensor probe into the center of water flow cavity of the coupling, allowing the user or care giver a high degree of confidence of safety when taking a shower or assisting another person with a shower.

### CROSS REFERENCE TO RELATED APPLICATIONS

This non provisional utility application cross references provisional application #60/668,552 filed Apr. 5, 2005.

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISK APPENDIX

Not applicable

### BACKGROUND OF THE INVENTION

To allow the elderly, caregivers, or anyone to know the temperature of the water flowing from a shower head is of a safe and desired temperature to the accuracy of 1/10^{th} of one degree Fahrenheit or Celsius. The lack of a prior simple to install device with this needed accuracy creates an important need.

### BRIEF SUMMARY OF THE INVENTION

An in line coupling with a digital thermometer attached for the shower that simply screws on to the water supply pipe where your shower head would screw on, then screw your shower head onto this in line coupling. This allows the person or caregiver an accurate read within 1/10^{th} of one degree Fahrenheit or Celsius for a safe and preferred shower temperature.

### BRIEF DESCRIPTION OF THE SEVERAL VIEWS OF THE DRAWING

FIG. 1 In line coupling with digital thermometer attached by threading the male Threaded ¼″×⅛″−27 tapered piped threaded collar into the matching female threads in coupling.

FIG. 2 In line coupling installed between the shower water supply pipe and the shower head, showing the digital thermometer.

FIG. 3 Thermometer probe shown, attached to coupling, in center of water flow chamber.

FIG. 4 Face of thermometer

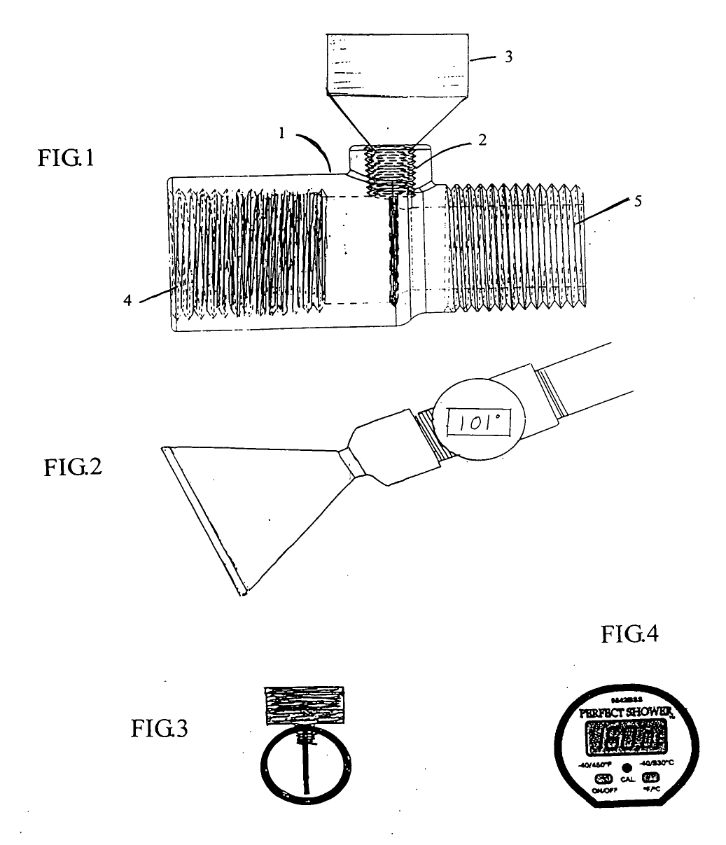

### DETAILED DESCRIPTION OF THE INVENTION

This new screw on inline shower temperature thermometer invention consists of three parts, The rigid coupling part 1, the threaded ¼″⅛″−27 tapered pipe thread collar permanently bonded around the thermometer probe 2, and the fast read digital thermometer 3.

The coupler part is made of ABS, but could be made of similar materials or metals. It can be made most any color. There is a machined threaded collar with male threads permanently bonded to, and that surrounds the conventional digital thermometer probe, which allows for the attachment or removal of the thermometer with the female threads molded in the middle center of coupler, inserting the thermometer sensor probe into the water flow cavity. The thermometer has a replaceable battery, an on/off switch and a switch for Fahrenheit or Celsius readings.

The rigid coupler is manufactured with female ½″ NPT threads 4, on one end for attaching to a standard shower water supply pipe by simply screwing on, and male ½″ NPT thread 5, on the opposing end which allows the shower head to be screwed on to, allowing a simple in line connection that incorporates a fast read digital thermometer.

I claim:

1. A new in line shower water thermometer device which is a rigid in line coupler which has female threads on one end for simply screwing onto a shower water supply pipe, and has male threads on the opposing end to allow a shower head to be screwed on to it, further incorporating a fast read digital thermometer with an accuracy of 1/10^{th} of one degree Fahrenheit or Celsius, attached to it by way of designed and machined male threaded collar that is permanently bonded to and surrounding the thermometer sensor probe, enabling easy attachment or removal from coupling by screwing or unscrewing thermometer into matching female threads located middle center of rigid coupling, allowing the thermometer sensor probe to be inserted into the water flow cavity of the in line coupling, further allowing the user to almost instantly, and with accuracy, to within 1/10^{th} of one degree Fahrenheit or Celsius, know the temperature of the water flowing from the shower head allowing for a safe and desired shower temperature to be attained.
